(19) United States
(12) Patent Application Publication
(10) Pub. No.: US 2026/0331998 A1
(43) Pub. Date: Oct. 22, 2026

(54) MOTOR ASSEMBLY

(71) Applicant: Dyson Technology Limited, Malmesbury, Wiltshire (GB)

(72) Inventors: Samuel John SHAW, Swindon (GB); Humza GILLETT-WALLER, Bristol (GB); Max Timothy Vernon SALT, Swindon (GB); Charles William Morvryn REYNOLDS, Swindon (GB)

(21) Appl. No.: 19/486,799

(22) PCT Filed: May 14, 2024
(86) PCT No.: PCT/IB2024/054666

§ 371 Date: Nov. 21, 2025

(30) Foreign Application Priority Data
May 31, 2023 (GB) 2308113.6

(51) Int. Cl. H02K 5/24; H02K 5/04

(52) U.S. Cl. CPC H02K 5/24; H02K 5/04

(57) ABSTRACT

A motor housing for housing a motor. The motor housing includes a cavity for receipt of a motor such that, when received therein, the motor housing at least partly circumferentially surrounds the motor. The motor housing includes an outer side facing away from the cavity, an inner side facing towards the cavity, a plurality of circumferentially spaced, axially extending outer recesses formed in the outer side for receiving one or more elongate electrically conductive elements, and a plurality of circumferentially spaced, axially extending inner recesses formed in the inner side. Each inner recess is disposed between a respective pair of spaced neighbouring outer recesses in the circumferential direction.

### BACKGROUND

Appliances such as haircare appliances or vacuum cleaners often include electromechanical and/or electrical components (such as motors). Such components can be particularly susceptible to being damaged (e.g. to the point of no longer operating) if the appliance receives a significant shock load, which may occur, for example, if the appliance is dropped.

To protect these types of components from damage, they are typically provided within a housing, that may be received in an external (i.e. main) housing of the appliance. In some cases, a mount can be provided between the housing and the component to further aid in the prevention of damage to the component under a shock load.

Known mounts sometimes include one or more features (such as protrusions) that contact the component housing to support the mount within the housing and to provide vibration isolation. Further features (such as protrusions) are sometimes provided on a mount to absorb against shock. These are typically spaced from the component housing so as not to contact the housing in normal use. This is desirable to maximise vibration isolation. When a shock occurs (e.g. due to an impact) the component housing moves relative to the mount such that the shock absorbing features come into contact with the housing. The shock absorbing features are caused to deform, which helps to absorb the force associated with the shock.

### SUMMARY

In a first aspect, there is disclosed a motor housing for housing a motor, the motor housing comprising:
a cavity for receipt of a motor;
an outer side facing away from the cavity;
an inner side facing towards the cavity;
a plurality of transversely spaced elongate outer recesses formed in the outer side for receiving one or more elongate electrically conductive elements (e.g. wires, cables, flexible printed circuit boards); and
a plurality of transversely spaced elongate inner recesses formed in the inner side;
wherein:
   at least one inner recess of the plurality of inner recesses is disposed between a respective pair of neighbouring outer recesses; and/or
   at least one outer recess of the plurality of outer recesses is disposed between a respective pair of neighbouring inner recesses.

The motor housing of the first aspect can allow mounting of a motor within an appliance in a manner that is space efficient, while providing sufficient structural rigidity to help prevent damage to the motor in both normal use and when the motor undergoes a significant shock.

It is often desirable to minimise the external dimensions of an appliance, especially when the appliance is intended to be handheld in use. This conflicts, however, with the need to provide some form of protection around some components (such as motors) to prevent such components being damaged under shock loading. Seeking to minimise the external envelope of an appliance, in some cases, can leave very little space available in an appliance housing for positioning of a motor together with a motor housing and mount. This issue can be exacerbated by the need, in some contexts, to position further components of the appliance, such as wiring, around the motor (or motor housing).

To address a lack of space, the motor housing (and motor mount) can be reduced in size, but this reduces the ability of these parts to withstand shock loading. Alternatively, the size of the motor can be decreased, but this will typically reduce the performance of the appliance. Or, in a further alternative, the size of the appliance can be increased, but this of course conflicts with the aim of minimising the size of the appliance.

As mentioned above, however, the motor housing of the first aspect provides a further solution which maintains the size of the motor and its ability to withstand shock, while avoiding the need to increase the size of the appliance.

Firstly, the axially elongate outer recesses of the motor mount provide space for components, such as wiring, of the appliance to pass around the motor. Secondly, the inner recesses can accommodate parts of a motor mount (or motor), which can provide more space efficient mounting of the motor housing around the motor mount and/or motor. Thirdly, providing inner recesses between the outer recesses (or vice-versa), rather than aligning the inner/outer recesses, can help minimise the thickness of the housing. For example, the space between a neighbouring pair of inner recesses can be utilised for receipt of a wire (i.e. in an outer recess). Fourthly, the described arrangement of outer and inner recesses, which essentially forms an undulating-like structure, can provide a stiffer structure that can more readily protect a motor held therein. Hence, the stiffness of the robustness of the motor housing (and e.g. a motor assembly of which the motor housing may form part) may be increased by the provision of the undulating shape. As may be appreciated, the inner and/or outer recesses may only be provided across a portion/section of the housing, in which case the structural benefits may be particularly present at that portion of the housing.

For the avoidance of doubt, the transverse direction is a direction that is substantially perpendicular to the direction in which each recess extends (i.e. the direction of elongation of each recess).

Optional features of the first aspect will now be set out. These are applicable singly or in any combination with any aspect.

The motor housing may have a substantially tubular shape.

The motor housing (and e.g. the cavity) may have a substantially circular profile (taken in the transverse direction). The motor housing may have a substantially elliptical profile. In such embodiments, the transverse direction may be a circumferential direction (i.e. the recesses may be circumferentially spaced).

The motor housing may alternatively have other shaped profiles, such as e.g. a triangular, rectangular or hexagonal profile.

The inner and outer recesses may be arranged to form elongate corrugations in the motor housing (e.g. each corrugation in the form of an outwardly projecting ridge). Such corrugations may act as stiffeners to stiffen the motor housing, allowing it to better withstand shock loading.

Each corrugation may have a substantially trapezoidal cross-sectional shape taken in the transverse direction (i.e. with one of the parallel “sides” of the trapezoid omitted, forming an open side of the corrugation). As may be appreciated, the corrugations may have other cross-sectional shapes (e.g. may be substantially U-shaped).

Each corrugation may comprise a central wall (e.g. oriented transversely/circumferentially) provided between two opposite sidewalls (each of which may extend generally towards the cavity of the motor housing). Each sidewall may extend on a slope (i.e. may be obliquely oriented with respect to the central wall). Each sidewall may extend on a slope away from the other of the sidewalls (and e.g. away from the central wall).

Each inner recess may be defined within a respective corrugation. Each inner recess may have a substantially trapezoidal cross-sectional shape.

Each outer recess may be defined between adjacent corrugations. Each outer recess may have a substantially U-shaped cross-sectional shape.

Each outer recess may have a depth (i.e. the extension of the recess into the outer side) and/or width (i.e. in the transverse direction) that is between 1 mm and 3 mm, or e.g. between 1.5 mm and 2.5 mm, or e.g. that is about 1.8 mm.

The outer recesses may differ from one another in cross-sectional shape and/or size (e.g. may have different depths).

Each (i.e. inner and/or outer) recess may have a transverse cross-sectional shape that is substantially symmetrical (e.g. about a radially extending axis of symmetry). Each recess may have a transverse cross-sectional shape that is asymmetrical. For example, one or more of the corrugations may have an asymmetrical shape. As an example, one sidewall of a corrugation may have a shallower slope than the other sidewall of a corrugation. This may be desirable, for example, where an outer recess is defined on only one side of a corrugation (in which case the other side of the corrugation may not need to extend inwardly towards the cavity as far as the side at which the outer recess is defined).

The inner recesses may be arranged in a substantially regular pattern (which may be a repeating pattern) around the inner side of the motor housing. For example, at least three (or e.g. at least four) of the inner recesses may be evenly spaced from one another (in the transverse/circumferential direction). The inner recesses may be provided in groups of evenly spaced recesses (spaced in the transverse/circumferential direction).

The motor housing may comprise at least three outer recesses. The motor housing may comprise e.g. at least six outer recesses, e.g. may comprise eight outer recesses.

The motor housing may comprise at least three inner recesses. The motor housing may comprise e.g. at least six inner recesses, or e.g. at least eight inner recesses, e.g. may comprise ten inner recesses.

The outer recesses may be arranged in a substantially regular pattern (e.g. a repeating pattern) around the outer side of the motor housing. In an embodiment, the plurality of transversely spaced elongate outer recesses are evenly spaced from one another. For example, at least three (or e.g. at least four) of the outer recesses may be evenly spaced from one another (in the transverse/circumferential direction). The outer recesses may be provided in groups of evenly spaced recesses (spaced in the transverse/circumferential direction).

Each recess may follow a curved path. Each recess may follow a substantially linear path.

In some embodiments, the recesses may extend helically about the inner and outer sides of the motor housing. In other embodiments, each recess may be substantially parallel to a central axis of the motor housing (i.e. may extend in an axial direction of the motor housing).

Each outer recess may extend for substantially at least the full length of the motor housing. The length of the motor housing is in the axial direction (i.e. the direction of extension of the elongate recesses). For the avoidance of doubt, for the purposes of determining the length, when the motor housing forms a portion of a larger component, the extent of the motor housing is taken to be only the portion of the larger component that extends around the motor.

Each recess may have a width dimension extending in the transverse/circumferential direction. Each inner recess may be wider than each outer recess.

Each recess may be spaced apart from one or more neighbouring recesses by a spacing distance. The spacing distance of the inner recesses may be greater than the spacing distance of outer recesses.

The motor housing may be formed of a substantially rigid material. For example, the motor housing may be formed of polycarbonate (PC) or acrylonitrile butadiene styrene (ABS).

The motor housing may comprise a depth dimension defined as the distance between the inner and outer sides. Each inner and outer recess may have a depth that is greater than 10% of the depth of the motor housing, or e.g. greater than 30% of the depth of the motor housing (e.g. greater than 40% of the depth dimension of the motor housing).

The motor housing may comprise a thickness dimension, which may be defined as the distance between inner and outer surfaces of the motor housing. The thickness of the motor housing may be substantially uniform.

For the avoidance of doubt, the reference to a “side” is a reference to a nominal reference surface that extends across the innermost or outermost parts of the motor housing, into which each recess extends. On the other hand, a reference to a “surface” is a reference to a physical surface of the motor housing (i.e. each surface defining the respective recesses defined in the sides). Thus, the above described “depth” dimension is equivalent to the distance (taken along an inwardly/radially extending line) between an outermost point of the motor housing and an inner most point of the motor housing. The thickness dimensions, on the other hand, is the distance between the outer and inner surfaces, taken normal to the inner/outer surfaces.

The motor housing may be formed of two motor housing halves, which may be joined to form the motor housing. The two motor housing halves may join along an axially extending reference plane. Each motor housing half may have a substantially semi-circular or semi-elliptical transverse profile.

One or both motor housing halves may be an internal chassis for an appliance (i.e. when assembled). The chassis (or each chassis) may be configured to accommodate (and e.g. retain) components of the appliance such as e.g. a PCB, display, seals, sensors, foam, etc.).

In a second aspect, there is disclosed a motor assembly comprising:
a motor housing according to the first aspect; and
a motor received in the cavity of the motor housing.

Optional features of the second aspect will now be set out. These are applicable singly or in any combination with any aspect.

The motor assembly may comprise a motor mount provided between the motor and motor housing. The motor mount may comprise a mount body at least partly surrounding the motor. The motor mount may comprise a plurality of resilient protrusions (e.g. bumps) projecting outwardly from the body.

The mount body may be substantially tubular. Thus, the mount body may fully circumferentially surround the motor. The mount body may be resilient (may be formed of a resilient material). The mount body (i.e. with the motor received therein) may be in a stretched configuration (i.e. may be expanded from a natural configuration thereof), so as to be under tension. In other words, the motor may be at least partly retained within the mount body by way of compression of the mount body around the motor.

The mount body and/or protrusions may be formed of a material that is more flexible than the motor housing.

A distal end of each protrusion (i.e. distal from the mount body) may contact an inner surface of the motor housing. In this way, the mount may be supported within the motor housing by way of the contact between the protrusions and the inner surface of the motor housing. For the avoidance of doubt, references to such contact herein are references to contact in normal use (i.e. not necessarily under shock loading) unless otherwise stated.

Each protrusion may extend into an inner recess of the motor housing. Receipt of the protrusions into the inner recesses in this way may restrict relative movement of the mount and motor housing in the transverse/circumferential direction (e.g. may restrict relative rotation about a central axis extending through the motor).

That is, the motor housing may be spaced from the mount body by the plurality of resilient protrusions. Spacing the motor housing from the mount body may allow the resilient protrusions to act as shock absorbers. For example, when a shock load is imparted on the motor assembly, one or more of the resilient protrusions may compress as the motor housing is forced towards the mount body (and thus the motor). Providing a space between the motor housing and the mount body allows for such compression (i.e. rather than the force being transferred directly from the motor housing to the mount body).

The motor mount may be as described in the third aspect discussed below (and may include one or more of the optional features of the third aspect).

In a third aspect, there is provided a motor mount for providing shock absorption and vibration isolation between a motor and a motor housing, the motor mount comprising:
a body defining a cavity for receipt of a motor, and
a plurality of discrete resilient bumps protruding outwardly from the body, each bump having a proximal end at the body and an opposite distal end for contacting the inner surface of a motor housing in use;
wherein each bump has a substantially convex shape such that a transverse cross-sectional area of the bump increases in non-linear manner from the distal end to the proximal end.

The shape of each bump allows the bump to provide both shock absorption and vibration isolation, which simplifies the design of the motor mount and reduces the space required for the motor mount in e.g. an appliance.

The convex shape of each bump means that a small contact area can be provided (i.e. at the apex of the bump) between the bump and an inner surface of a motor housing. This ensures that each bump is effective at isolating vibration between the motor mount and a motor housing within which it may be mounted.

Likewise, the non-linear increase in transverse cross-sectional area of each bump translates to a non-linear stiffness response as the distal end of the bump is compressed towards the proximal end of the bump. This, combined with the convex shape of the bump, means that stiffness may increase faster at the initial stages of such compression of the bump than at the later stages of compression. This is desirable with respect to shock absorption because a rapid increase in stiffness means faster absorption of the forces associated with a shock. This helps to prevent the bump from being substantially fully compressed under shock, which could otherwise result in contact between a motor housing (within which the mount may be received) and the body of the mount. Such contact is undesirable because it can result in a direct transfer of force to a motor received in the cavity, which could cause damage to the motor.

As the bumps provide effective vibration isolation there is no need to space the bumps from the inner surface of the motor housing. This is unlike the known mounts discussed above in which clearance is provided. Providing such clearance is not merely a case of reducing the size of the shock absorbing features, because doing so would inhibit the ability of such features to absorb shocks. Instead, this clearance must be accommodated by either providing a larger motor housing or by reducing the size of the motor. Accordingly, the motor mount of the third aspect can provide a more compact motor assembly (for a given motor size) as a result of not needing to provide clearance between the bumps and the motor housing.

Optional features of the third aspect will now be set out. These are applicable singly or in any combination with any aspect.

In general, each bump may have a shape in which there is a first region at or close to the distal end of the bump in which the cross-sectional area increases at a first rate, and a second region at or close to the proximal end of the bump in which the cross-sectional area increases at a second rate that is less than the first rate. The first region may be a region in which the cross-sectional area of the bump increases rapidly. This may translate into a rapid increase in the stiffness response as the bump is compressed (e.g. under shock loading).

Each bump is substantially dome-shaped. Each bump may have a cross-sectional shape (taken perpendicular to the direction of protrusion of the bump) that is circular or elliptical. Each bump may have a cross-sectional shape that is non-circular. For example, the cross-sectional shape may approximate a circular or elliptical shape, or may be e.g. hexagonal, rectangular, triangular, etc.

Each bump may be substantially hemispherical. Each bump may have a substantially hemispherical shape albeit with a planar distal end.

The outer surface of each bump may have a radius of curvature that is between 0.5 mm and 50 mm, or e.g. between 0.5 mm and 20 mm, or e.g. between 0.5 mm and 10 mm.

Each bump may have a substantially planar region provided at the distal end of the bump. The planar region may be arranged for contacting the inner surface of the motor housing in use. The planar region may e.g. be a circular region. The planar region may e.g. have a diameter of between 0.5 mm and 2.0 mm, or e.g. between 1.0 mm and 1.5 mm, or e.g. about 1.1 mm. Providing such a region may ensure contact between the bump and the motor housing, in use, occurs at this region, which may provide more consistent performance of the bumps (e.g. under compression due to shock).

An outer surface of each bump may be joined to an outer surface of the body at the distal end of the bump by a fillet surface having a concave profile. The fillet surface may reduce or avoid stress concentrations that could otherwise occur with an abrupt transition between the bump and the body of the mount. This may reduce or avoid failure of each bump e.g. during shock or as a result of fatigue.

The body of the mount may be substantially tubular. The bumps may protrude outwardly (i.e. radially outwardly) from a circumferential outer surface of the body.

At least two of the plurality of bumps may be spaced circumferentially from one another on the outer surface of the body.

At least two of the plurality of bumps may be spaced axially from one another on the outer surface of the body.

The plurality of bumps may be arranged in axially extending, circumferentially spaced, rows of bumps. For example, each row of bumps may comprise at least three bumps. The mount may comprise at least three rows of bumps, or e.g. at least four rows of bumps, or e.g. may consist of six rows of bumps.

The rows of bumps may be spaced evenly in the circumferential direction around the outer surface of the body.

Each bump may be integrally formed with the body to form a unitary piece. The mount may be formed of a resilient material (e.g. a polymeric material, such as polyurethane rubber).

In a fourth aspect, there is provided a motor assembly comprising:
a motor mount according to the third aspect; and
a motor housing at least partly surrounding the motor mount, the motor housing having an inner surface facing the motor mount; and
wherein the distal end of each bump contacts the inner surface of the motor mount.

Optional features of the fourth aspect will now be set out. These are applicable singly or in any combination with any aspect.

The inner surface of the motor housing may comprise a plurality of inner recesses. The distal end of each bump may contact the inner surface within an inner recess of the motor housing.

The motor housing may be substantially tubular so as to substantially surround the motor mount. The inner recesses of the motor housing may be elongate (and may be axially extending).

Each inner recess may be defined by a central wall and two opposite side walls that extend towards the motor mount. The sidewalls may be sloped (e.g. may be obliquely arranged wit respect to the central wall). The sidewalls may slope away from one another, and e.g. away from the central wall. The sidewalls may be symmetrical or may be asymmetrical (e.g. one sidewall may extend on a shallower angle than the other).

The motor assembly may comprise the motor.

The motor housing of the fourth aspect may be as described above with respect to the first aspect (e.g. the motor housing may include one or more of the optional features of the first aspect).

The motor assembly of the fourth aspect may be as described above with respect to the second aspect (e.g. may include one or more optional features of the second aspect).

In a fifth aspect, there provided an appliance comprising a motor assembly according to the second aspect or the fourth aspect.

Optional features of the fifth aspect will now be set out. These are applicable singly or in any combination with any aspect.

The appliance may comprise an appliance housing extending circumferentially about the outer side of the motor housing.

The appliance may comprise one or more elongate electrically conductive elements (e.g. wires, flexible printed circuit boards, cables) forming part of an electrical componentry of the appliance. The one or more elongate electrically conductive elements may be received in one or more of the outer recesses of the motor housing.

The appliance may be a vacuum cleaner or a hair care appliance.

As may be appreciated, while the above aspects make reference to a motor, they may be equally applicable to other electrical or electro-mechanical components. In this respect references to a “motor” in the above discussed aspects could be replaced with references to an electrical or electro-mechanical component.

### BRIEF DESCRIPTION OF THE DRAWINGS

FIG. 1 is a perspective view of a motor assembly provided within an appliance; and

FIG. 2 is a section view of the motor assembly of FIG. 1;

FIG. 3 is a detailed section view of part of the motor assembly of FIG. 1;

FIG. 4 is a perspective view of a motor mount of the motor assembly of FIG. 1; and

FIG. 5 is a section view of a bump of the motor mount of FIG. 4.

### DETAILED DESCRIPTION

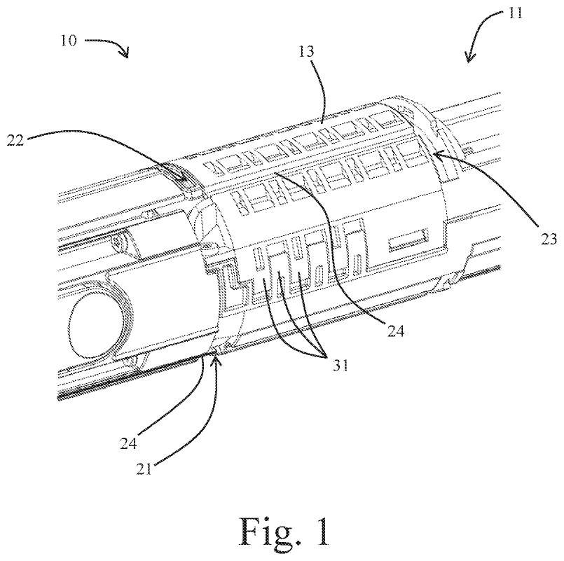

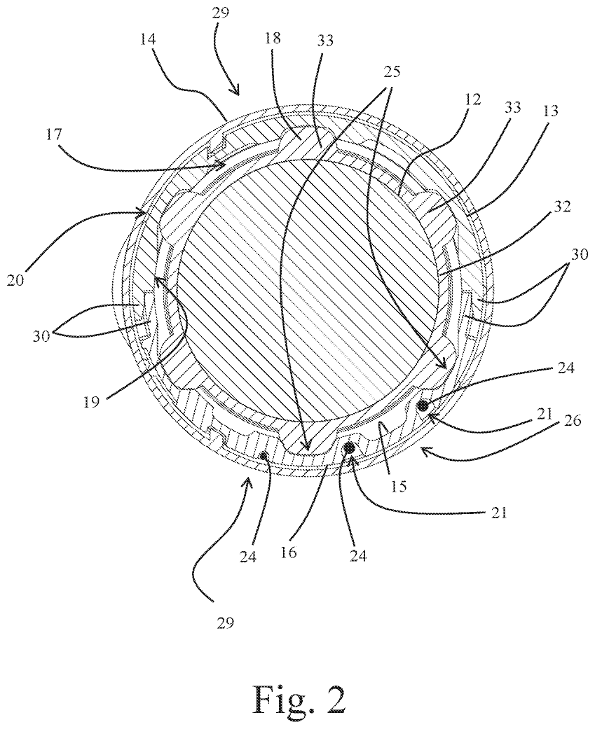

FIGS. 1, 2 and 3 illustrate a motor assembly 10 provided as part of an appliance 11 (which in this case is a vacuum cleaner). The motor assembly 10 includes a substantially cylindrical motor 12, a motor mount 18, and a motor housing 13. The motor assembly 10 is disposed within a tubular portion (in this case, a handle) of an external housing 14 of the appliance 11 (shown in FIG. 2 but is omitted in FIG. 1 for clarity).

The motor housing 13 is substantially tubular. As discussed above, the thickness dimensions is defined between inner 15 and outer 16 surfaces of the motor housing 13, whereas a depth dimension of the motor housing 13 is taken to be the distance D between inner 19 and outer 20 sides). A substantially cylindrical cavity 17 is defined within the motor housing 13, within which the motor 12 and the motor mount 18 are received. The inner side 19 of the motor housing 13 faces inwardly towards this cavity 17, and the opposite outer side 20 of the motor housing 13 faces outwardly and away from the cavity 17. The outer side 20 of the motor housing 13 is in contact with an inner surface of the external housing 14 of the appliance 11.

Three circumferentially spaced elongate outer recesses 21 are formed in the outer side 20 of the motor housing 13.

Each outer recess 21 extends axially along a linear path from a first axial end 22 of the motor housing 13 to a second axial end 23 of the motor housing 13. The outer recesses 21 are parallel to one another and are also parallel with a central axis of the motor housing 13. In other embodiments, however, the outer recesses 21 may extend helically about the outer side 20 of the motor housing 13.

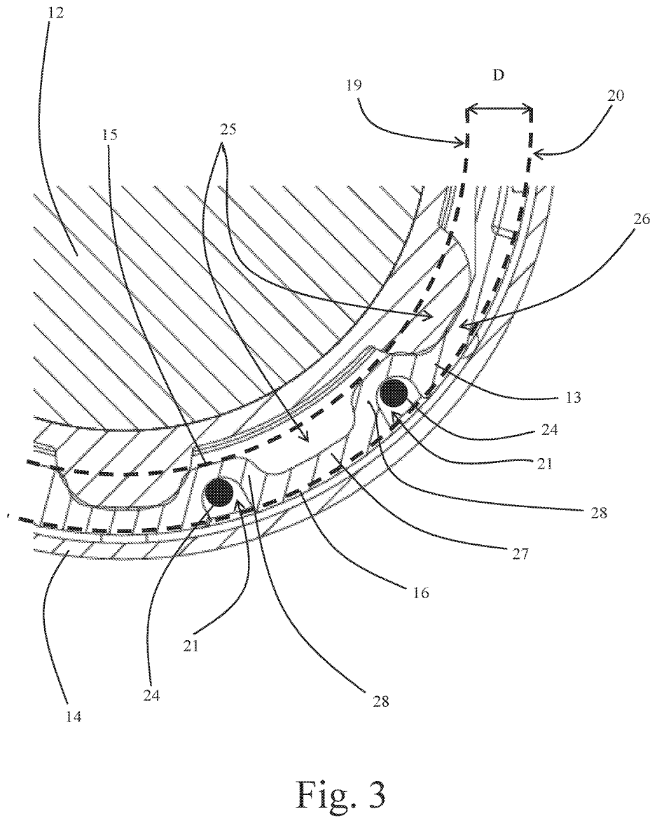

Each outer recess 21 has a profile (i.e. cross-sectional shape taken in the transverse/circumferential direction) that is substantially U-shaped. This is best seen in FIG. 3.

The outer recesses 21 each provide a space between the motor housing 13 and the external appliance housing 14 within which elongate electrically conductive elements, in the form of wires 24, of the appliance 11 are received. This means the dimensions of the external appliance housing 14 do not need to be increased to accommodate such wiring (i.e. the outer dimensions of the portion of the appliance 11 surrounding the motor housing 13 can be minimised).

The motor housing 13 also includes ten elongate inner recesses 25. Like the outer recesses 21, the inner recesses 25 are circumferentially spaced from one another, and each inner recess 21 extends axially along a linear path from the first axial end 22 of the motor housing 13 to the second axial end 23 of the motor housing 13. In this way, the inner recesses 25 are parallel to one another, and are also parallel with the central axis of the motor housing 13 (and, further, are parallel with the outer recesses 21).

The outer recesses 21 are offset circumferentially from the inner recesses 25. Thus, each of the outer recesses 25 is disposed between (in the circumferential direction) a respective pair of neighbouring inner recesses 24. This aids in minimising the depth of the motor housing 13 (i.e. provides a more efficient use of space).

The inner 25 and outer 21 recesses form elongate corrugations 26 in the motor housing 13, such that the portion of the motor housing 13 at which the recesses 21, 24 are provided has a generally corrugated shape. This shape increases the stiffness of the motor housing 13 (e.g. when compared to a non-corrugated tube of the same thickness), at least in the region in which the corrugations are provided.

Each corrugation 26 comprises an outer circumferential wall 27 (as shown in FIG. 3) and two opposite radially extending sidewalls 28 extending towards the cavity 17 from axially extending edges of the circumferential wall 27.

Each corrugation 26 defines a respective inner recess 25. The outer recesses 21 are defined between adjacent corrugations 26 and, have a U-shaped profile (i.e. formed between the sidewalls 28 of adjacent corrugations 26).

The motor housing 13 is formed of two motor housing halves 29 (which are upper and lower halves as illustrated). Each motor housing half 29 has a substantially semi-circular shape, such that the two motor housing halves 29 join along a plane that extends axially along the central axis of the motor housing 13. To provide such joining, each motor housing half 29 comprises two axially extending joining edges 30 that each include a plurality of axially spaced circumferentially extending fingers 31. The fingers 31 of the motor housing halves 29 are arranged in an interdigitated manner when the two motor housing halves 29 are joined (as shown in FIG. 1). The interdigitation of the finger 31 provides frictional retention to aid in mounting the halves 29 together.

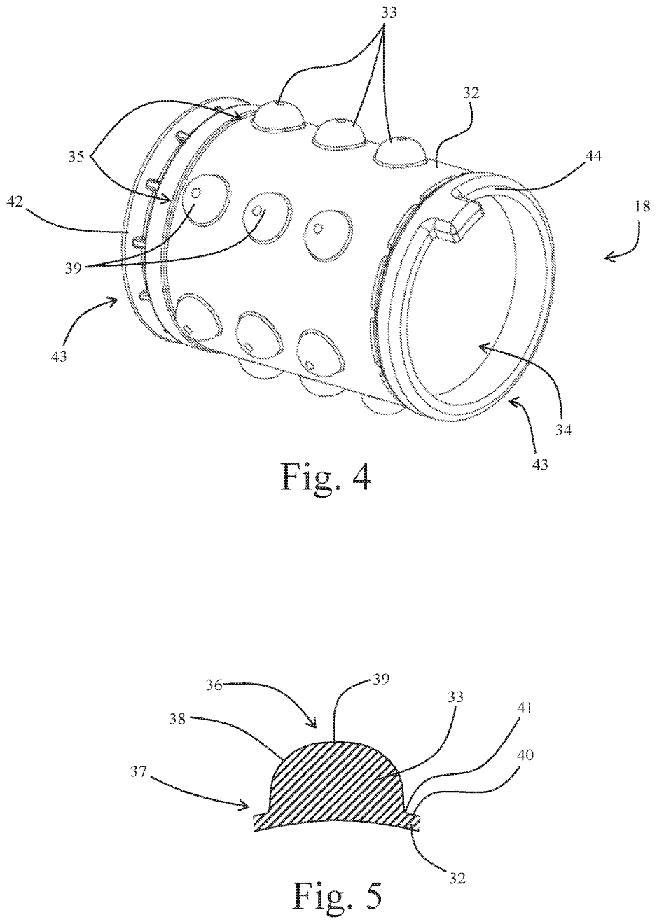

The motor mount 18 is positioned (radially) between the motor 12 and the motor housing 13 and is shown in more detail in FIG. 4. The motor mount 18 is an integrally formed unitary piece and includes a body 32 and eighteen discrete resilient bumps 33 that protrude outwardly from the body 32.

The body 32 is tubular so as to define a substantially cylindrical cavity 34 in which the motor 12 is received. To help retain the motor mount 18 relative to the motor 12, the mount 18 is formed of resilient material (e.g. a rubber) and, when mounted, is in a stretched configuration. That is, the body 32 is sized such that a diameter of the motor-receiving cavity 34 is smaller than an outer diameter of the motor 12. In this way, to mount the motor mount 18 to the motor 12, the body 32 must be expanded (i.e. stretched). Once mounted, the body 32 applies a compressive force to the motor 12 to retain the motor 12 in the cavity 34.

The eighteen resilient bumps 33 of the motor mount 18 are arranged in six axially extending rows 35 of bumps 33, each row 35 consisting of three bumps 33 that are spaced apart from one another in the axial direction. The rows 35 of bumps 33 are circumferentially spaced from one another evenly about the body 32 of the motor mount 18.

The shape of each bump 33 is best shown in FIG. 4, which shows a single bump 33 of the motor mount 18 (although it should be appreciated that each bump 33 is identical). The bump 33 has a substantially hemispherical shape, such that a transverse cross-sectional area of the bump 33 increases in a non-linear manner from a distal end 36 (distal from the body 32) to a proximal end 37 (proximal the body 32) of the bump 33. In particular, the cross-sectional area increases at a greater rate in a region close to the distal end 36 than at the proximal end 37 (this should be apparent from the substantially horizontal orientation of an outer surface 38 of the bump 33 at the distal end 36 which transitions to a substantially vertical orientation at the proximal end 37).

At the distal end 36, the bump 33 includes a circular planar region 39. This planar region 39 (and substantially only this planar region 39) of the outer surface 38 of the bump 33 is in contact with the motor housing 13, in particular with the inner surface 15 of the motor housing 13. Providing this region 39 as a planar region helps to ensure that any contact with the inner surface 15 of the motor housing 13 occurs at this region 39. This provides better control of vibration isolation and shock absorbing functions of the bump 33 (which are described further below).

At the proximal end 37, where the bump 33 connects to the body 32, the outer surface 38 of the bump 33 is joined to an outer surface 40 of the body 32 by a curved fillet surface 41 having a concave profile. This fillet surface 41 provides a smooth transition between the bump 33 and the body 32 of the motor mount 18. One benefit of this fillet surface 41 is to avoid stress concentrations in use, which could otherwise occur with a more abrupt transition between the bump 33 and the body 32.

As has been explained above, the shape of the bump 33 allows the bump 33 to perform two functions in a particularly effective manner. Firstly, the shape of the bump 33 is such that there is a relatively small region 39 of contact with the motor housing 13. Minimising contact with the motor housing 13 provides a reduction in the vibrations (created by operation of the motor 12) transmitted from motor mount 18 to the motor housing 13. Thus, the bumps 33 allow the motor mount 18 to support the motor 12 within the motor housing 13 in a manner whereby the motor housing 13 is effectively isolated from vibration of the motor 12. This can reduce the noise emitted by the appliance 11 in use and can also reduce vibration felt by a user of the appliance 11.

The second function performed by the bumps 33 is to absorb shocks that may occur, for example, if the appliance 11 is dropped during use. In use, when a large load is applied to the bump 33 via the contact with the motor housing 13, the distal end 36 of the bump 33 will compress towards the body 32 of the mount 18. When this occurs, it is desirable for the bump 33 to provide sufficient resistance such that the motor housing 13 is unable to impact the motor body 32 so as to “bottom out” (and thus transfer significant force to the motor 12 itself). This resistance is provided in the way of stiffness.

The hemispherical shape of the bump 33 means that, as the bump 33 is compressed (e.g. by a shock) the stiffness increases in a rapid manner, because of the rapid increase in cross-sectional area of the bump 33 at the distal end 36. This rapid increase in stiffness aids in absorbing the shock and preventing the motor housing 13 from bottoming out on the body 32 of the motor mount 18. In a similar manner, the curvature of the fillet surface 41 at the proximal end 37 of the bump 33 provides a further rapid increase in stiffness (i.e. if the compression reaches this point). In this way, the bump 33 provides both vibration isolation and shock absorption.

In addition to the bumps 33, the motor mount 18 also includes a circumferentially extending seal 42, provided at an end 43 of the motor mount 18. The seal 42 extends fully around the circumference of the motor mount 18 and projects radially to the motor housing 13. At an opposite end 43 of the motor mount 18, a retaining ring 44 is provided that aids in (axially) retaining a motor within the cavity 34.

Returning now to FIG. 2, it should be apparent that each of the six rows 35 of bumps 33 is aligned with a respective elongate inner recess 25 of the motor housing 13. Each bump 33 therefore extends into a respective inner recess 25 so as to contact the inner surface 15 of the motor housing 13 within the respective inner recess 25. The contact between the bumps 33 and the motor housing 13 supports the motor 12 within the motor housing 13 and spaces the motor housing 13 from the body 32 of the motor mount 18. By providing such clearance, in the event of a shock, the motor housing 13 is able to move towards the body 32 without immediately contacting the body 32 and transferring force to the motor 12.

Likewise, the receipt of the bumps 33 within the inner recesses 25 also restricts relative rotation of the motor housing 13 and the motor mount 18 about the central axis. Such rotation could otherwise occur during normal use of the appliance 11.

The shape of each inner recess 25 can also have an effect on the stiffness response of the bumps 33 as they are compressed. For example, the sloped sidewalls 28 of each corrugation 26 of the motor housing 13 can help to prevent a bump 33 received therebetween from expanding outwardly (i.e. away from a central axis of the bump 33) as it is compressed. This can provide improved control of the compression of the bump 33 and thus the stiffness response. As may be appreciated, the shape of each inner recess 25 may be tailored to provide various responses (for example, the slope of the sidewalls 28 may be altered and may be different from one another).

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For example, the described embodiment includes three outer recesses, but in other embodiments more (or fewer) outer recesses may be provided. Likewise, the outer recesses may be provided in arrangements other than that illustrated. For example, the outer recesses may be evenly (circumferentially) spaced from one another. The outer recesses may be provided in two groups of evenly spaced outer recesses (e.g. each group provided on a respective motor half). An even number of outer recesses may be provided. Where the outer recesses are provided in two groups, each group may have the same number of outer recesses. In this way, in some embodiments, each motor half may have substantially the same shape.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A motor housing for housing a motor, the motor housing comprising:
a cavity for receipt of a motor;
an outer side facing away from the cavity;
an inner side facing towards the cavity;
a plurality of transversely spaced elongate outer recesses formed in the outer side for receiving one or more elongate electrically conductive elements; and
a plurality of transversely spaced elongate inner recesses formed in the inner side;
wherein:
at least one inner recess of the plurality of inner recesses is disposed between a respective pair of spaced neighbouring outer recesses in the circumferential direction; and/or
at least one outer recess of the plurality of outer recesses is disposed between a respective pair of neighbouring inner recesses.

2. The motor housing according to claim 1, wherein the plurality of inner recesses and plurality of outer recesses are arranged to form elongate corrugations in the motor housing.

3. The motor housing according to claim 2, wherein each corrugation has a substantially trapezoidal cross-sectional shape taken in the transverse direction.

4. The motor housing according to claim 1, wherein the plurality of inner recesses are arranged in a substantially regular pattern around the inner side of the motor housing.

5. The motor housing according to claim 1, comprising wherein the plurality of outer recess comprises at least three outer recesses and the plurality of inner recess comprises at least three inner recesses.

6. The motor housing according to claim 1, wherein the plurality of outer recesses are arranged in a substantially regular pattern around the outer side of the motor housing.

7. The motor housing according to claim 1, wherein the plurality of inner recesses extend helically about the inner side of the motor housing and the plurality of outer recesses extend helically about the outer sides of the motor housing.

8. The motor housing according to claim 1, wherein each recess is substantially parallel to a central axis of the motor housing.

9. The motor housing according to claim 1, wherein each of the plurality of inner recess and plurality of outer recesses has a width dimension extending in the transverse direction and each inner recess is wider than each outer recess.

10. The motor housing according to claim 1, comprising a depth dimension defined as the distance between the inner and outer sides, and wherein each of the plurality of inner and each of the plurality of outer recess has a depth that is greater than 15% of the motor housing.

11. The motor housing according to claim 1, comprising a thickness dimension defined as the distance between inner and outer surfaces of the motor housing, and wherein the thickness of the motor housing is substantially uniform.

12. The motor housing according to claim 1, formed of two motor housing halves joined to form the motor housing.

13. A motor assembly comprising:
the motor housing according to claim 1; and
a motor received in the cavity of the motor housing.

14. The motor assembly according to claim 13, comprising a motor mount provided between the motor and motor housing, the motor mount comprising a mount body at least partly surrounding the motor, and a plurality of resilient protrusions projecting outwardly from the body.

15. The motor assembly according to claim 14, wherein a distal end of each protrusion contacts an inner surface of the motor housing.

16. The motor assembly according to claim 14, wherein each protrusion extends into an inner recess of the motor housing.

17. The motor assembly according to claim 14, wherein the motor housing is spaced from the mount body by the plurality of resilient protrusions.

18. An appliance comprising:
the motor assembly according to claim 13;
an appliance housing at least partly surrounding the outer side of the motor housing; and
one or more elongate electrically conductive elements forming part of an electrical componentry of the appliance, the one or more elongate electrically conductive elements received in one or more of the plurality of outer recesses of the motor housing.

19. The appliance according to claim 18, that is a vacuum cleaner or a hair care appliance.
